(19) United States
(12) Patent Application Publication
(10) Pub. No.: US 2015/0262744 A1
(43) Pub. Date: Sep. 17, 2015

(54) Structure for a Magnetic Block

(71) Applicant: Zhengpeng WEI, GUANGDONG PROVINCE (CN)

(72) Inventor: Zhengpeng WEI, GUANGDONG PROVINCE (CN)

(21) Appl. No.: 14/298,962

(22) Filed: Jun. 8, 2014

(30) Foreign Application Priority Data
Mar. 12, 2014 (CN) 201410089071.3

(51) Int. Cl. H01F 7/02

(52) U.S. Cl. CPC H01F 7/02

(57) ABSTRACT

The present invention discloses a structure for a magnetic block, the block being a polyhedron, wherein all or some housing surfaces of the block are embedded with a radially magnetized magnet, via which radially magnetized magnet any two blocks can be attached and spliced with each other; an inner side of a housing surface embedded with the magnet is provided with a magnet installing plate and encapsulates a closed cavity with the inner side of the housing surface, and the magnet is embedded in the cavity and rotates freely about its own axis to adjust magnetic poles. The present solution adopts the structure in which a magnet installing plate encapsulates a cavity on a housing surface of a block, further encapsulating a radially magnetized magnet rotating freely and axially, thereby realizing low cost and high efficiency of manufacture and installation of magnetic blocks.

### BACKGROUND OF THE INVENTION

The present invention relates to the technical field of splicing blocks, in particular, toy-dedicated and education-dedicated splicing blocks, to be more specific, magnetic splicing blocks characterized by teaching in joy.

Previously, the inventor put forward a wholly new magnetic block different from traditional blocks. Such magnetic block is provided with magnetic assemblies on every surface; six surfaces of any block can be engaged in outward magnetic splicing in any direction, and splicing manners are diversified, such that numberless splicing shapes can be realized and transformed. Moreover, the magnetic manner enables the splicing to be more relax and interesting, capable of better helping children to not only acquire knowledge but also enjoy themselves while stacking up blocks, thereby really realizing the educational ideal of teaching in joy. In addition, due to adoption of magnetic assemblies, such magnetic blocks can be adhered to any magnetic panel (e.g., teaching white board), more convenient for teaching, with enhanced practicability.

However, such blocks suffer from the following disadvantages during the manufacturing: numerous and jumbled working procedures, and relatively difficult development of molds, which disadvantages are not favorable for batch productions. Hence, it is necessary to optimize and innovate the internal structure for magnetic blocks.

### BRIEF SUMMARY OF THE INVENTION

To solve the above problems, the present invention intends to provide a structure for a magnetic block with optimized structure and easy for manufacturing and assembling.

In order to realize the technical objective, the solution of the present invention is as follows: a structure for a magnetic block, the block being a polyhedron, wherein all or some housing surfaces of the block are embedded with a radially magnetized magnet, via which radially magnetized magnet any two blocks can be attached and spliced with each other; an inner side of a housing surface embedded with the radially magnetized magnet is provided with a magnet installing plate, a closed cavity is encapsulated between the installing plate and the inner side of the housing surface, and the magnetized magnet is embedded in the cavity and rotates freely about its own axis to adjust magnetic poles.

As a preferred embodiment, the housing surface is classified as a side surface and a cover surface encapsulating the side surface; the magnet installing plate for the side surface is a magnet baffle, which is arranged parallel to the side surface and is plugged or pulled in the inner side of the side surface, and encapsulates a closed cavity; the magnetized magnet is embedded in the cavity and rotates freely about its own axis; the magnet installing plate for the cover surface is a magnet pressing piece, which is fixed and installed in the inner side of the cover surface and encapsulates a closed cavity; the magnetized magnet is embedded in the cavity and rotates freely about its own axis.

As a further improvement, the radially magnetized magnet is any one of circular magnet, ring magnet or spherical ball magnet; the inside diameter of the cavity is greater than the outside diameter of the magnetized magnet.

As a further improvement, the material of the housing surface can be any one of plastic, wood, sponge, and fiber.

As a further improvement, the cavity of the side surface is disposed on the magnet baffle, and the inner side of the side surface is a polished panel.

As a further improvement, the cavity of the side surface is disposed on the magnet baffle, and the inner side of the side surface is a polished panel.

As a further improvement, the cavity of the cover surface is disposed on the corresponding magnet pressing piece.

As a further improvement, the cover surface and the side surface, and the cover surface and the magnet pressing piece are fixed with each other via screw fixation or ultrasonic welding.

The present solution adopts the structure in which a magnet installing plate encapsulates a cavity on a housing surface of a magnetic block, further encapsulating a radially magnetized magnet rotating freely and axially, thereby realizing low cost and high efficiency of manufacture and installation of magnetic blocks; in particular, adopting the encapsulating manner of plug and pull of a magnet baffle at the side surface, is characterized by excellence in structural design, further facilitating the processing and assembling; the cover surface adopts a magnet pressing piece to encapsulate a cavity for assembling a magnet, with the advantages of connecting stably and processing and installing with ease; the whole solution greatly improves manufacturing efficiency of blocks, and reduces manufacturing difficulty and cost, thereby having an enhanced practicability.

### BRIEF DESCRIPTION OF THE DRAWINGS

FIG. 1 is a schematic diagram of the stereoscopic structure for the block according to Embodiment One of the present invention;

FIG. 2 is a first exploded view of the structure for the block according to Embodiment One of the present invention;

FIG. 3 is a second exploded view of the structure for the block according to Embodiment One of the present invention;

FIG. 4 is an exploded view of the structure for the block according to Embodiment Two of the present invention;

FIG. 5 is an exploded view of the structure for the block according to Embodiment Three of the present invention;

FIG. 6 is a schematic diagram of the stereoscopic structure for the block according to Embodiment Four of the present invention;

FIG. 7 is an exploded view of the structure for the block according to Embodiment Four of the present invention;

FIG. 8 is a schematic diagram of the stereoscopic structure for the block according to Embodiment Five of the present invention;

FIG. 9 is an exploded view of the structure for the block according to Embodiment Five of the present invention;

FIG. 10 is a schematic diagram of the stereoscopic structure for the block according to Embodiment Six of the present invention;

FIG. 11 is an exploded view of the structure for the block according to Embodiment Six of the present invention;

FIG. 12 is a schematic diagram of the stereoscopic structure for the block according to Embodiment Seven of the present invention;

FIG. 13 is an exploded view of the structure for the block according to Embodiment Seven of the present invention;

FIG. 14 is a schematic diagram of the stereoscopic structure for the block according to Embodiment Eight of the present invention;

FIG. 15 is an exploded view of the structure for the block according to Embodiment Eight of the present invention;

FIG. 16 is a schematic diagram of the stereoscopic structure for the block according to Embodiment Nine of the present invention;

FIG. 17 is an exploded view of the structure for the block according to Embodiment Nine of the present invention;

FIG. 18 is a schematic diagram of the stereoscopic structure for the block according to Embodiment Ten of the present invention;

FIG. 19 is an exploded view of the structure for the block according to Embodiment Ten of the present invention;

FIG. 20 is a schematic diagram of the stereoscopic structure for the block according to Embodiment Eleven of the present invention;

FIG. 21 is an exploded view of the structure for the block according to Embodiment Eleven of the present invention.

### DETAILED DESCRIPTION OF THE INVENTION

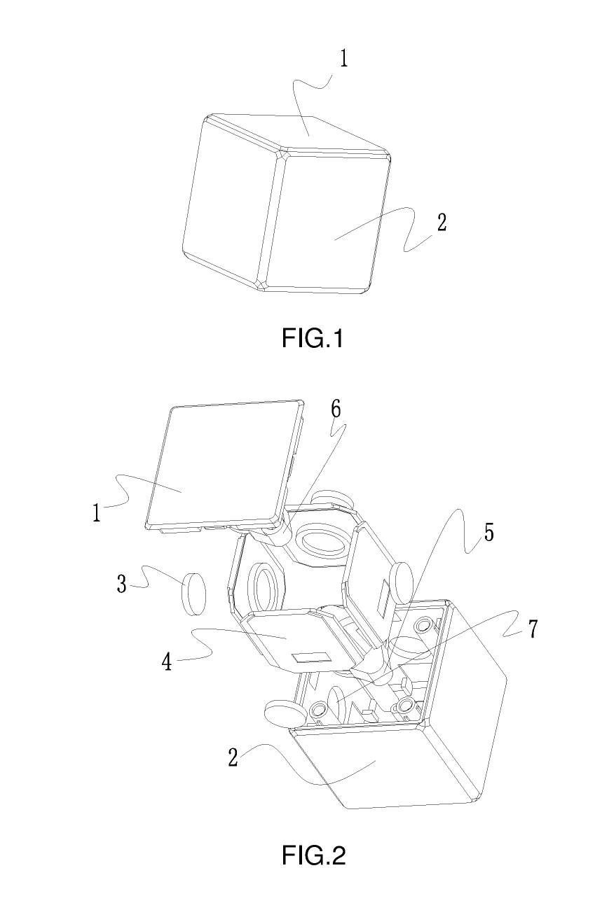

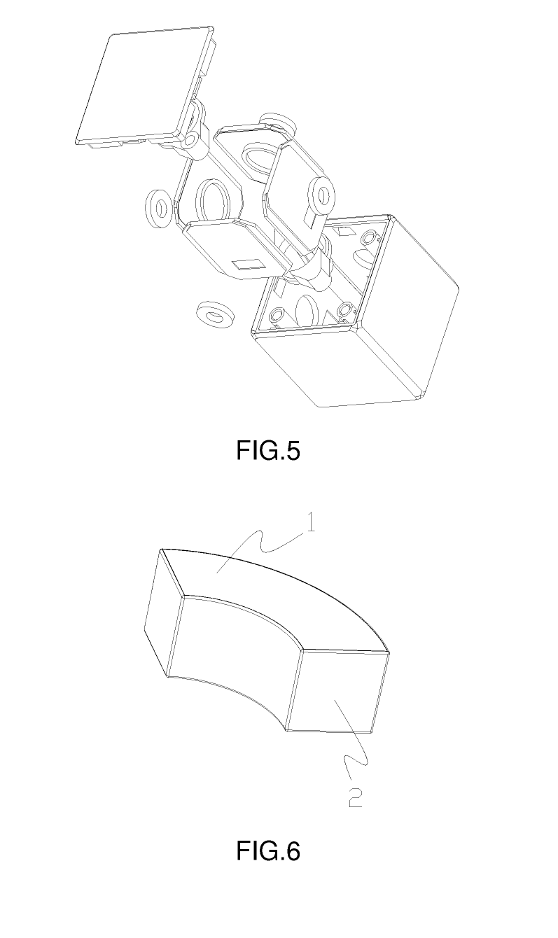

The present invention relates to a structure for a magnetic block, wherein the block is a polyhedron, as shown in FIGS. 1, 6, 8, 10, 12, 14, 16, 18 and 20, can be a cube, a sector, or a trapezoid, etc. All or some housing surfaces of the block are embedded with radially magnetized magnets 3, and the magnetism of the magnets on their surface after being radially magnetized is S-N relation; when two surfaces of two blocks come close to each other, if the same sides are N-S poles, the magnets are in a repulsion relation to each other, and then the radially magnetized magnets 3 will rotate in the cavities, and automatically adjust themselves to a position where the magnetic poles attract each other; any two blocks can be attached and spliced with each other via the radially magnetized magnets 3 (this is mainly realized by attachment between housing surfaces embedded with the magnetized magnets 3). In a preferred embodiment, the radially magnetized magnets can be a circular magnet (as shown in FIG. 2), can also be a ring magnet (as shown in FIG. 5) or a spherical ball magnet (as shown in FIG. 4); the inside diameter of the cavities is greater than the outside diameter of the magnetized magnets, for facilitating free rotation of the magnets.

An inner side of a housing surface embedded with the radially magnetized magnet 3 is provided with a magnet installing plate, a closed cavity is encapsulated between the installing plate and the inner side of the housing surface, and the magnetized magnet 3 is embedded in the cavity and rotates freely about its own axis to adjust magnetic poles. The housing surface is classified as a side surface 2 and a cover surface 1 encapsulating the side surface, and usually, the side surface is often a vertical surface in a use state, and the cover surface 1 is generally an upper cover or a bottom plate; the magnet installing plate for the side surface 2 is a magnet baffle 4, which magnet baffle 4 is arranged parallel to the side surface and is plugged or pulled in the inner side of the side surface 2, and encapsulates a closed cavity; the magnetized magnet 3 is embedded in the cavity and rotates freely about its own axis; the magnet installing plate for the cover surface 1 is a magnet pressing piece 5, which magnet pressing piece 5 is fixed and installed in the inner side of the cover surface 1 and encapsulates a closed cavity; the magnetized magnet 3 is embedded in the cavity and rotates freely about its own axis.

Now, the cube block is taken as the best embodiment of the present invention, with detailed depictions as follows.

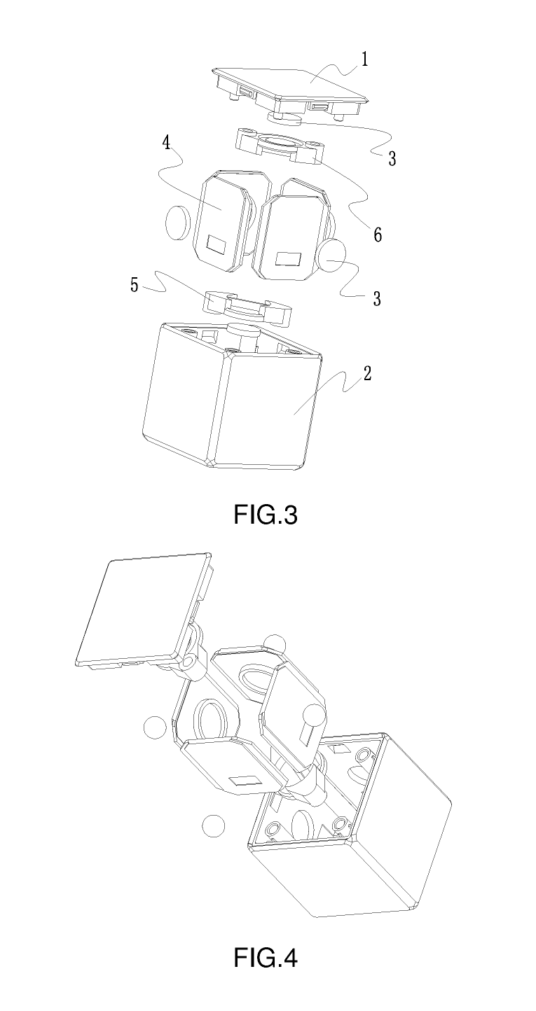

As shown in FIGS. 2 and 3, the block of the present invention is formed by installing an upper cover, one of the cover surfaces, on a five-surface housing, the five-surface housing is constituted by four side surfaces 2 and one bottom surface (another of the cover surfaces); each side surface 2 is provided with a pluggable magnet baffle 4, a closed cavity 7 is encapsulated between the side surface and the magnet baffle 4, and the magnetized magnet 3 is embedded in the cavity 7 and rotates freely about its own axis; the upper cover 1 and the bottom surface both are provided with magnet pressing pieces 5 and 6 for securing installation, a closed cavity is encapsulated between the magnet pressing piece 6 and the plastic upper cover 1 and the magnet pressing piece 5 and the bottom surface, and the magnetized magnet 3 is embedded in the cavity 7 and rotates freely about its own axis, so as to adjust magnetic poles for attaching to each other.

As a specific improvement, the cavity 7 of the side surface is disposed on the inner panel of the side surface, and the magnet baffle 4 is a polished panel. Certainly, the cavity 7 of the side surface can also be disposed on the magnet baffle 4, and the inner panel of the side surface is a polished panel. During specific manufacturing, no matter whether the side surface contains a cavity, one side of the magnet baffle is provided with a cavity; if the side surface is a smooth surface, the cavity surface of the magnet baffle is adopted to face towards it; if the side surface has a cavity, the smooth surface of the magnet baffle is adopted to face towards it. The cavities encapsulated by the upper cover 1 and the bottom surface are disposed on the corresponding magnet pressing pieces 5 and 6, and the magnet pressing pieces are fixed on the upper cover or the bottom surface via screw fixation or ultrasonic welding, or other fixation manners. The upper is fixed on the five-surface housing via screw fixation or ultrasonic welding, or other fixation manners.

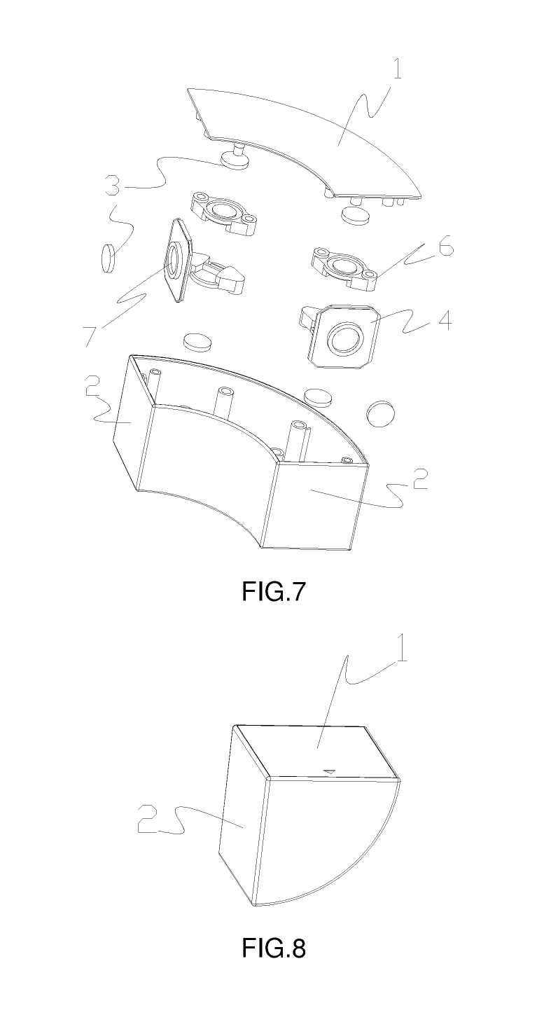

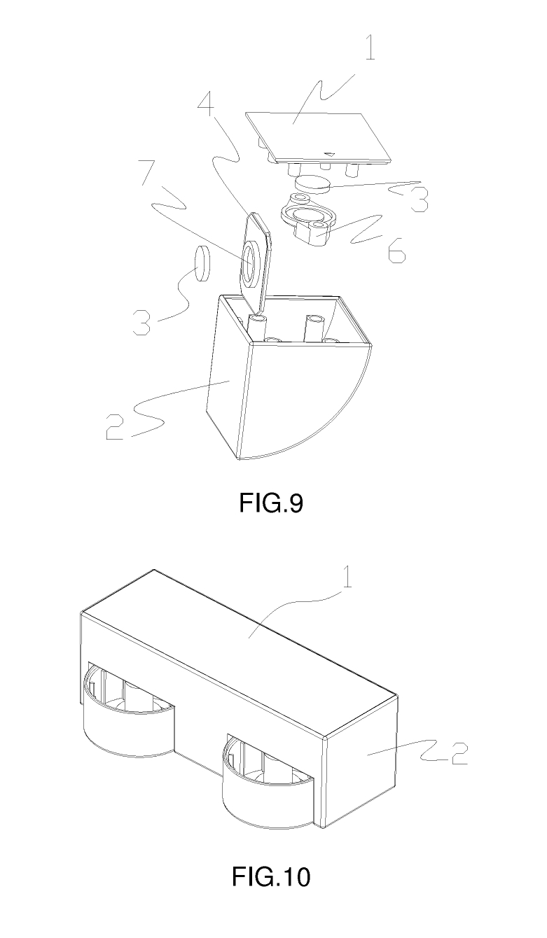

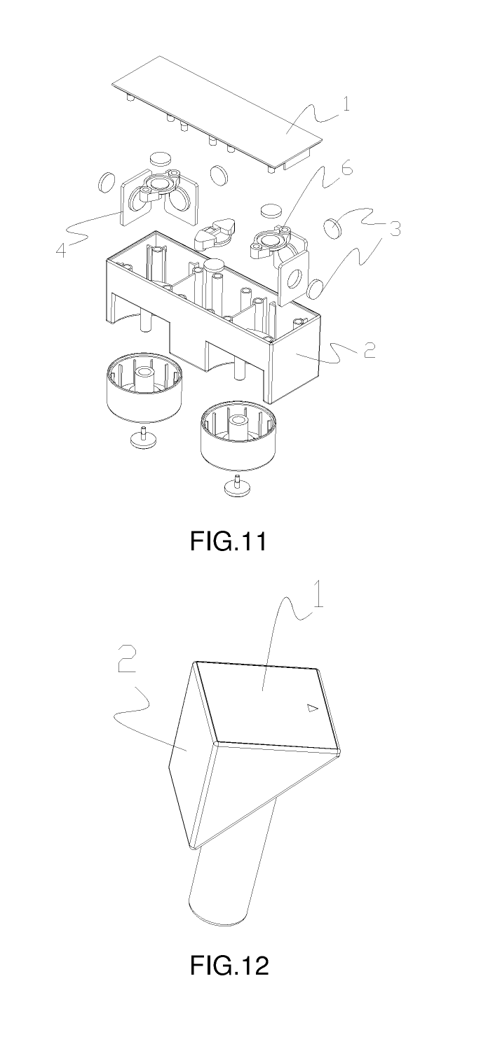

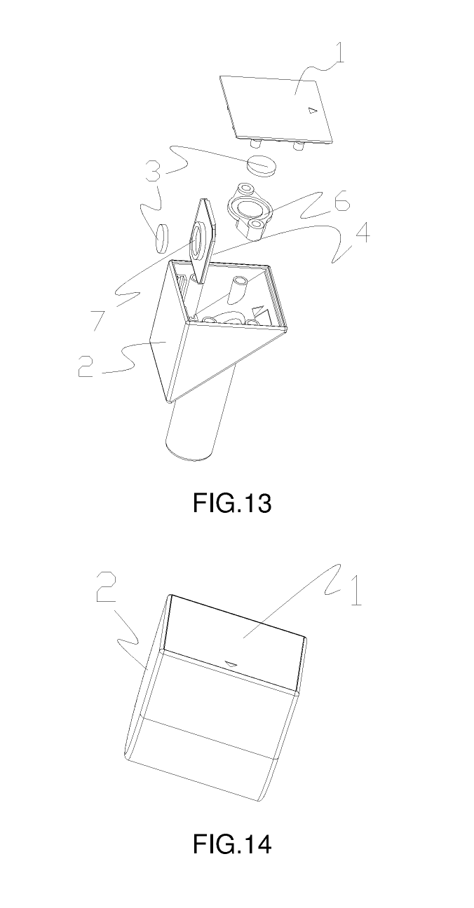

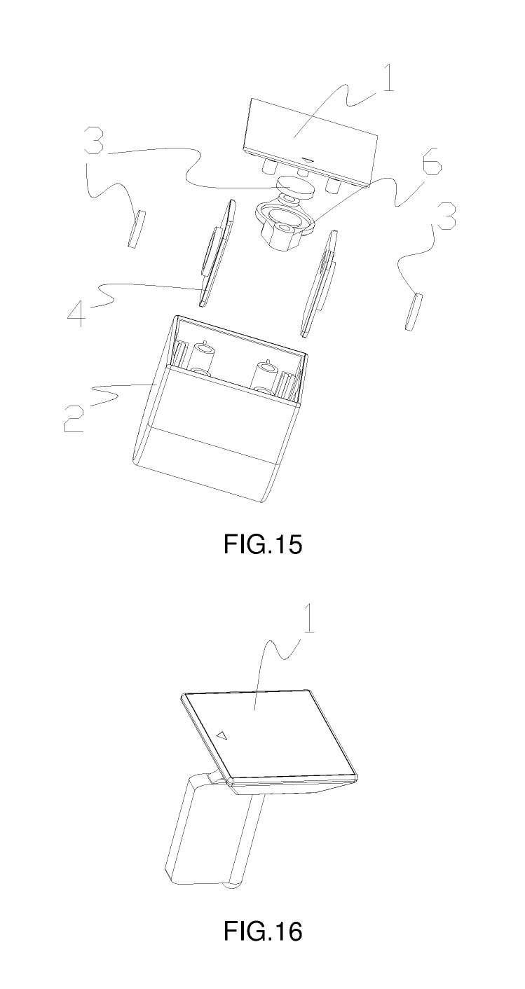

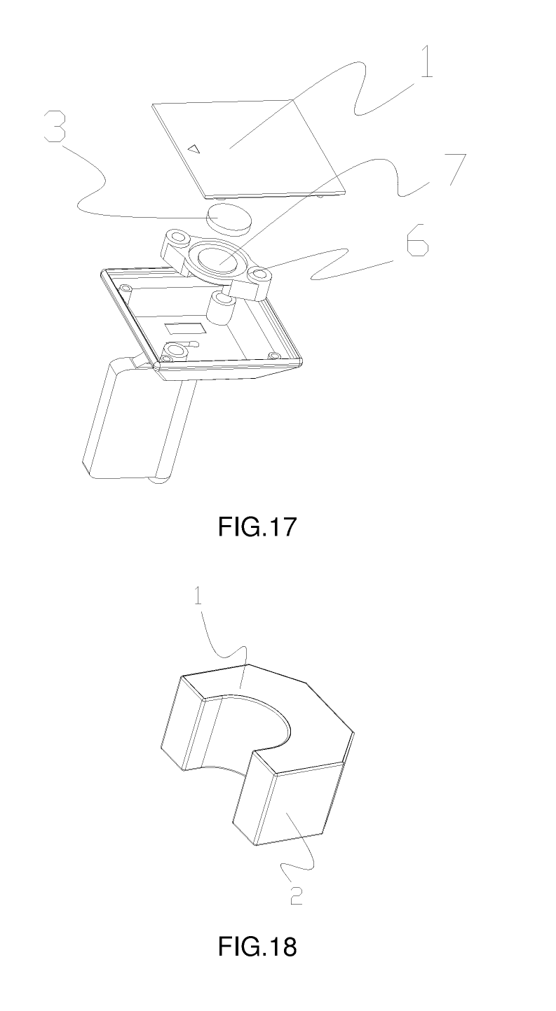

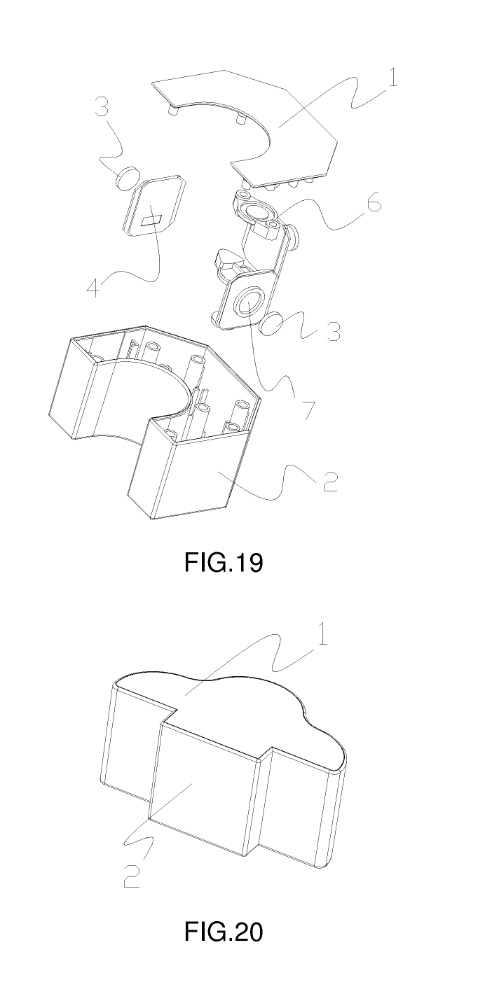

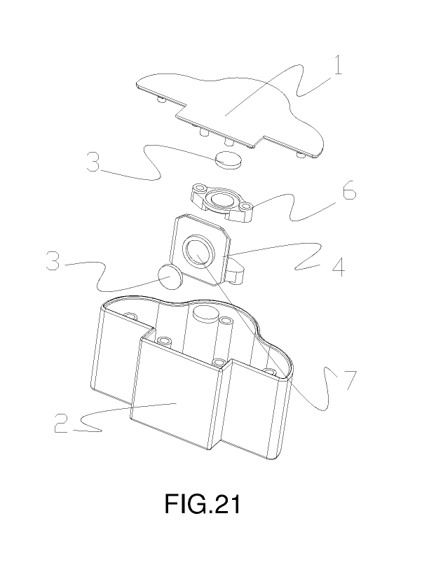

Likewise, Embodiment Four to Embodiment Eleven, as shown in FIGS. 6-21, represent specific structures of blocks with different shapes, whose technical characteristics are completely identical to those of the aforesaid best embodiment, and which are only applications aiming at different shapes, so no more details are provided. It should be stressed that, other shapes not shown in the present invention, are also equivalents of the present invention, and still fall within the protection scope of the present invention.

The material of the housing surfaces of the block involved in the present invention is a non-magnetic material, such as plastic, wood, sponge, fiber, etc.

All the contents as stated above, are only better embodiments of the present invention, and are not used to limit the present invention; any subtle amendment, equivalent replacement and improvement that is made to the above embodiments according to the technical substance of the present invention, shall fall within the protection scope of the technical solution of the present invention.

What is claimed is:

1. A structure for a magnetic block, the block being a polyhedron, characterized in that:
all or some housing surfaces of the block are embedded with a radially magnetized magnet, via which radially magnetized magnet any two blocks can be attached and spliced with each other;
an inner side of a housing surface embedded with the radially magnetized magnet is provided with a magnet installing plate, a closed cavity is encapsulated between the installing plate and the inner side of the housing surface, and the magnetized magnet is embedded in the cavity and rotates freely about its own axis to adjust magnetic poles.

2. The structure for the magnetic block according to claim 1, characterized in that:
the housing surface is classified as a side surface and a cover surface encapsulating the side surface;
the magnet installing plate for the side surface is a magnet baffle, which is arranged parallel to the side surface and is plugged or pulled in the inner side of the side surface, and encapsulates a closed cavity; the magnetized magnet is embedded in the cavity and rotates freely about its own axis;
the magnet installing plate for the cover surface is a magnet pressing piece, which is fixed and installed in the inner side of the cover surface and encapsulates a closed cavity; the magnetized magnet is embedded in the cavity and rotates freely about its own axis.

3. The structure for the magnetic block according to claim 2, characterized in that:
the radially magnetized magnet is any one of circular magnet, ring magnet or spherical ball magnet; the inside diameter of the cavity is greater than the outside diameter of the magnetized magnet.

4. The structure for the magnetic block according to claim 3, characterized in that:
the material of the housing surface can be any one of plastic, wood, sponge, and fiber.

5. The structure for the magnetic block according to claim 3, characterized in that:
the cavity of the side surface is disposed on the inner side of the side surface, and the magnet baffle is a polished panel.

6. The structure for the magnetic block according to claim 3, characterized in that:
the cavity of the side surface is disposed on the magnet baffle, and the inner side of the side surface is a polished panel.

7. The structure for the magnetic block according to claim 3, characterized in that:
the cavity of the cover surface is disposed on the corresponding magnet pressing piece.

8. The structure for the magnetic block according to any one of claims 2 to 7, characterized in that: the cover surface and the side surface, and the cover surface and the magnet pressing piece are fixed with each other via screw fixation or ultrasonic welding.
